(19) United States
(12) Patent Application Publication
(10) Pub. No.: US 2015/0185946 A1
(43) Pub. Date: Jul. 2, 2015

(54) TOUCH SURFACE HAVING CAPACITIVE AND RESISTIVE SENSORS

(71) Applicant: GOOGLE INC., Mountain View, CA (US)

(72) Inventor: Daniel Fourie, San Mateo, CA (US)

(73) Assignee: GOOGLE INC., Mountain View, CA (US)

(21) Appl. No.: 14/143,212

(22) Filed: Dec. 30, 2013

(51) Int. Cl. G06F 3/041; G06F 3/044; G06F 3/045; G02F 1/1333

(52) U.S. Cl. CPC G06F 3/0416; G02F 1/13338; G06F 3/044; G06F 3/045

(57) ABSTRACT

In one general aspect, a display apparatus includes a display, a capacitive sensor disposed on a top surface of the display and a resistive sensor disposed on a bottom surface of the display. In another general aspect, a method for assembling a display apparatus includes laminating a capacitive sensor to a top surface of a display and laminating a resistive sensor to a bottom surface of the display.

### TECHNICAL FIELD

This document relates, generally, to a touch surface having capacitive and resistive sensors.

### BACKGROUND

Trackpads, which may also be referred to as touchpads, are often used with computing devices, e.g., as pointing devices to facilitate user interaction with an associated computing device. Trackpads may be used with a computing device in place of, or in addition to, a mouse pointing device. For instance, trackpads are often implemented as integrated pointing devices for laptop computing devices, notebook computing devices and netbook computing devices. A trackpad may also be implemented as a non-integrated device that is coupled (e.g., as a peripheral device) to a computing device, such as a desktop computing device or a server computing device, as some examples. Trackpads may, of course, be implemented in other devices as well.

Touchscreen displays are often used with computing devices, including laptop computing devices, notebook computing devices, netbook computing devices, tablet computing devices, smart phones, and other computing devices to facilitate user interaction with an associated computing device.

Trackpad (touchpad) devices and touchscreen displays may include a tactile sensing surface (e.g., a capacitive sensing surface). The trackpad device is generally configured to facilitate interaction by a user with a graphical user interface (GUI) for an associated computing device and the touchscreen display is generally configured to facilitate direct interaction on the GUI by the user. For instance, a trackpad device or a touchscreen device may be configured to detect position and motion of a user's finger or fingers that are in contact with the tactile sensing surface. The detected motion and/or position of a user's finger or fingers on the trackpad or a touchscreen may then be used, by the computing device, to determine a relative position on a display screen (in a GUI) that corresponds with the position of the user's finger (or fingers), or to affect movement of a cursor in the GUI, as some examples.

Current trackpads and touchscreens, however, may have certain drawbacks. For instance, in some implementations, a user tapping a trackpad's surface or a touchscreen's surface may be used to indicate a mouse click, such as to select an item, locate a cursor or launch a program, as some examples. However, in such approaches, a user inadvertently and briefly touching the trackpad or the touchscreen may be recognized as an unwanted mouse click, which can result in undesired effects and be frustrating for the user. In other instances, a trackpad device may include separate buttons. In such implementations, a user may have to position his or her finger on the trackpad surface and simultaneously click one of the separate buttons in order to perform certain interactions with a GUI (such as to launch an application associated with an icon, select an object in the GUI or move an object in the GUI, as some examples), which may be awkward for the user.

### SUMMARY

In a general aspect, a display apparatus includes a display, a capacitive sensor disposed on a top surface of the display and a resistive sensor disposed on a bottom surface of the display.

In another general aspect, a computing device includes at least one processor, at least one memory and a display apparatus. The display apparatus includes a display, a capacitive sensor disposed on a top surface of the display and a resistive sensor disposed on a bottom surface of the display.

Implementations of the above general aspects may include one or more of the following features. For example, the capacitive sensor may be laminated to the top surface of the display and the resistive sensor may be laminated to the bottom surface of the display. The resistive sensor may include multiple traces and the traces may include transparent material. The resistive sensor may include multiple traces and the traces may include non-transparent material. The display apparatus may further include at least one controller operably coupled to the capacitive sensor and to the resistive sensor. The at least one controller and the capacitive sensor may be configured to detect one or more objects on the top surface of the display independent of the resistive sensor and the at least one controller may be configured to determine positioning and tracking of the one or more objects on the top surface using information from the detection by the at least one controller and the capacitive sensor. The at least one controller and the resistive sensor may be configured to detect one or more objects on the top surface of the display independent of the capacitive sensor and the at least one controller may be configured to determine click gestures and key presses from the one or more objects on the top surface using information from the detection by the at least one controller and the resistive sensor. The display may include a liquid crystal display (LCD) layer. The display may include an e-ink display layer.

In another general aspect, a method for assembling a display apparatus includes laminating a capacitive sensor to a top surface of a display and laminating a resistive sensor to a bottom surface of the display.

Implementations may include one or more of the following features. For example, the resistive sensor may include multiple traces and the traces may include transparent material. The resistive sensor may include multiple traces and the traces may include non-transparent material. The method may include securing the laminated capacitive sensor, display and resistive sensor assembly into a computing device. The capacitive sensor, the display and the resistive sensor may include a polyethylene terephthalate (PET) substrate.

The details of one or more implementations are set forth in the accompanying drawings and the description below. Other features will be apparent from the description and drawings, and from the claims.

### BRIEF DESCRIPTION OF THE DRAWINGS

FIG. 1A is a drawing illustrating a computing device in accordance with an example implementation.

FIG. 1B is a drawing illustrating a computing device in accordance with an example implementation.

FIG. 1C is a drawing illustrating a computing device in accordance with an example implementation.

FIG. 2A is a block diagram illustrating a pressure-sensitive touch surface apparatus in accordance with an example implementation.

FIG. 2B is a block diagram illustrating a pressure-sensitive touch surface apparatus in accordance with an example implementation.

FIG. 3 is a diagram illustrating a pressure-sensitive touchscreen apparatus in accordance with an example implementation.

FIGS. 4A and 4B are diagrams illustrating operation of a pressure-sensitive touchscreen apparatus in accordance with an example implementation.

FIG. 5 is an example flow diagram illustrating an example process for assembling a display apparatus.

### DETAILED DESCRIPTION

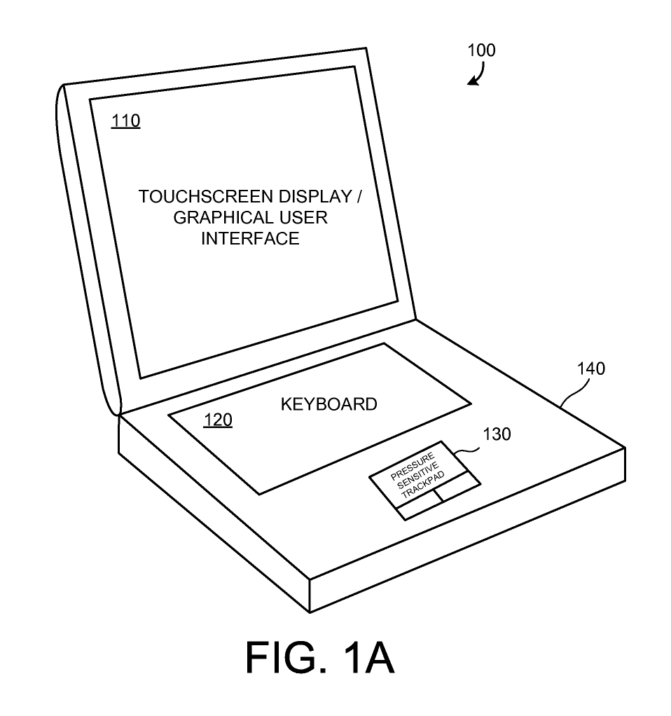

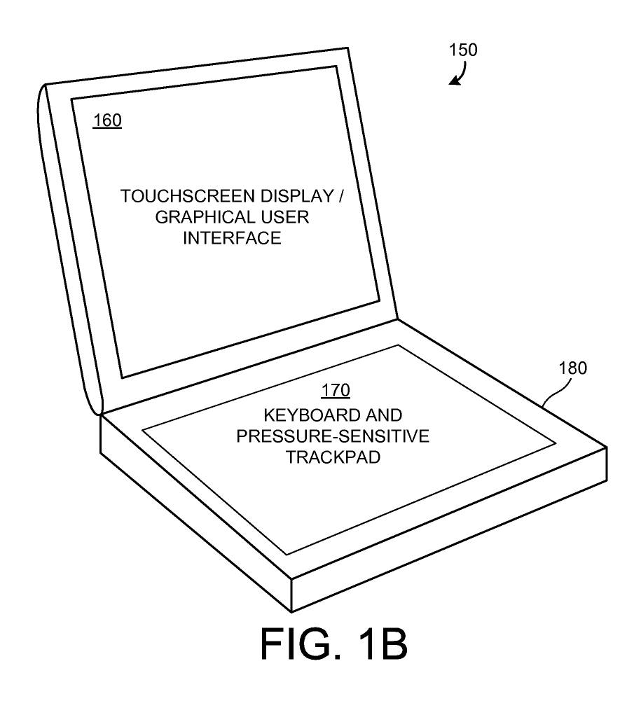

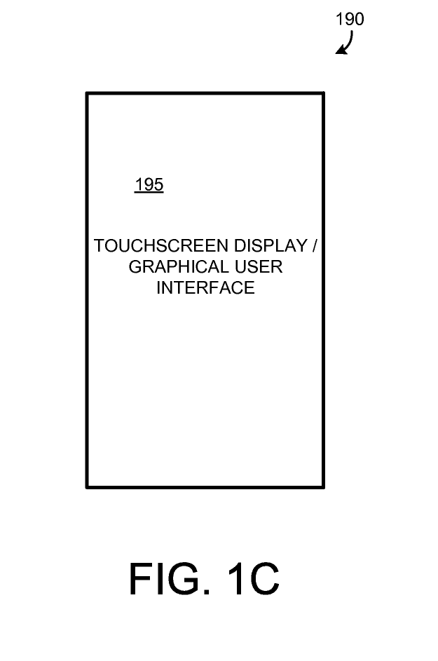

FIG. 1A is a drawing illustrating a computing device 100 in accordance with an example implementation. It will be appreciated that the computing device 100 is shown by way of example, and for purposes of illustration. In some implementations, the computing device 100 may take the form of a laptop computer, a notebook computer or netbook computer, or a smart phone device. In other implementations, the computing device 100 may have other configurations. For instance, the computing device 100 may be a tablet computer, a desktop computer, a server computer, or a number of other computing or electronics devices where a pressure-sensitive trackpad apparatus (trackpad device) 130 and/or a touchscreen display 110, such as those described herein, may be used to facilitate interaction with a corresponding device (e.g., via a graphical user interface (GUI)). Throughout this document, the terms trackpad, trackpad device, trackpad apparatus, touchpad, touchpad device and touchpad apparatus may be used interchangeably. Similarly, the terms touchscreen, touchscreen device, touchscreen display, touchscreen display device and touchscreen apparatus may be used interchangeably throughout this document. Also throughout this document, the terms computing device, computing system and electronic device may be used interchangeably.

The computing device 100 shown in FIG. 1A includes a touchscreen display device 110, a keyboard 120, a pressure-sensitive trackpad apparatus 130 and a chassis 140. As indicated in FIG. 1A, the touchscreen display device 110 (e.g., in conjunction with other elements of the computing device 100) may be configured to render a GUI that allows a user to interact with the computing device 100, such as to run programs, browse the Internet or World Wide Web, or draft documents, as some examples. A user of the computing device 100 may interact with the computing device 100 via the GUI rendered on the touchscreen display device 110 by directly touching and interacting with the touchscreen display device 110, such as to move a cursor, select objects, launch programs from icons or move objects in the GUI, as some examples. The touchscreen display device 110 may be implemented in a number of ways, such as using the techniques described herein, for example. The user of the computing device 100 also may interact with the computing device 100 via the GUI rendered on the touchscreen display device 110 using the keyboard 120, such as to enter text or commands. The keyboard 120 may take a number of forms, and the particular arrangement of the keyboard 120 will depend on the particular implementation. It will be appreciated that the particular configuration of the touchscreen display device 110 may vary and the configuration used will depend on the specific implementation. For instance, the touchscreen display device 110 may be larger, or smaller in some implementations. For example, in one implementation, the touchscreen display device 110 may include substantially the entire top surface of the computing device when implemented as a tablet computing device or a smart phone, such as described below with respect to FIG. 1C.

A user may also interact with the computing device 100 via the GUI rendered on the display device 110 using the pressure-sensitive trackpad 130, such as to move a cursor, select objects, launch programs from icons or move objects in the GUI, as some examples. Of course, other interactions with the GUI are possible using the pressure-sensitive trackpad 130. The trackpad 130 may be implemented in a number of ways, such as using the techniques described herein, for example. It will be appreciated that the particular configuration of the trackpad 130 may vary and the configuration used will depend on the specific implementation. For instance, the trackpad may be larger, or smaller in some implementations. For example, in one implementation, the trackpad may be increased in size and be disposed in (replace) the area that includes the keyboard 120, such as described below with respect to FIG. 1B.

The chassis 140 of the computing device 100 may be used to house various components of the computing device 110, such as the trackpad 130, a processor motherboard and system memory (e.g., including volatile and non-volatile memory), as well as a number of other components. The chassis 140 may also be used to establish an electrical ground, which may also be referred to as chassis ground, for one or more components of the computing device 100, such as for the trackpad 130. For instance, in one example, the chassis 140 may comprise a metal frame within a polymer housing. In this example, the metal frame of the chassis 140 may be connected to an electrical ground of a power supply that is included in the computing device 100 in order to provide electrical (chassis) ground to the trackpad 130. It will be appreciated that other arrangements for providing a chassis ground are possible.

FIG. 1B is a drawing illustrating a computing device 150 in accordance with an example implementation. It will be appreciated that the computing device 150 is shown by way of example, and for purposes of illustration. In some implementations, the computing device 150 may take the form of a laptop computer, a notebook computer or netbook computer. In other implementations, the computing device 150 may have other configurations. For instance, the computing device 150 may be a tablet computer, a desktop computer, a server computer, or a number of other computing or electronics devices where a combined keyboard and pressure-sensitive trackpad apparatus (trackpad device) 170, such as those described herein, may be used to facilitate interaction with a corresponding device (e.g., via a graphical user interface (GUI)). Additionally, a touchscreen display device 160 may be used to facilitate interaction with the device.

The computing device 150 shown in FIG. 1B includes a touchscreen display device 160, a combined keyboard and pressure-sensitive trackpad apparatus 170 and a chassis 180. As indicated in FIG. 1B, the touchscreen display device 160 (e.g., in conjunction with other elements of the computing device 150) may be configured to render a GUI that allows a user to interact with the computing device 150, such as to run programs, browse the Internet or World Wide Web, or draft documents, as some examples. A user of the computing device 150 may interact with the computing device 150 via the GUI rendered on the touchscreen display device 160 using the touchscreen display device 160.

A user of the computing device 150 also may interact with the computing device 150 using the combined keyboard and pressure-sensitive trackpad 170. For instance, the user may use the keyboard and trackpad 170 both to enter text or commands and for actions such as moving a cursor, selecting objects, launching programs from icons or moving objects in the GUI, as some examples. The keyboard and trackpad 170 may take a number of forms, and the particular arrangement of the keyboard and trackpad 170 will depend on the particular implementation. The keyboard and trackpad 170 may be implemented in a number of ways, such as using the techniques described herein, for example.

It will be appreciated that the particular configuration of the keyboard and trackpad 170 may vary and the configuration used will depend on the specific implementation. For instance, keyboard and trackpad 170 may be configured to function as both the keyboard and the trackpad and the keyboard and trackpad 170 may be configured to distinguish between keyboard actions and trackpad actions.

The chassis 180 of the computing device 150 may be used to house various components of the computing device 150, such as the keyboard and trackpad 170, a processor motherboard and system memory (e.g., including volatile and non-volatile memory), as well as a number of other components. The chassis 180 may also be used to establish an electrical ground, which may also be referred to as chassis ground, for one or more components of the computing device 150, such as for the keyboard and trackpad 170. For instance, in one example, the chassis 180 may comprise a metal frame within a polymer housing. In this example, the metal frame of the chassis 180 may be connected to an electrical ground of a power supply that is included in the computing device 150 in order to provide electrical (chassis) ground to the keyboard and trackpad 170. It will be appreciated that other arrangements for providing a chassis ground are possible.

FIG. 1C is a drawing illustrating a computing device 190 in accordance with an example implementation. It will be appreciated that the computing device 190 is shown by way of example, and for purposes of illustration. In some implementations, the computing device 190 may take the form of a tablet computer or a smart phone device. In other implementations, the computing device 190 may have other configurations.

The computing device 190 shown in FIG. 1C includes a touchscreen display device 195. As indicated in FIG. 1C, the touchscreen display device 195 (e.g., in conjunction with other elements of the computing device 190) may be configured to render a GUI that allows a user to interact with the computing device 190, such as to run programs, browse the Internet or World Wide Web, make phone calls or draft documents, as some examples. A user of the computing device 190 may interact with the computing device 190 via the GUI rendered on the touchscreen display device 195 using the touchscreen display device 195. The touchscreen display device 195 may include a soft keyboard that is displayed as part of the GUI and the user may interact with the soft keyboard using the touchscreen display device 195.

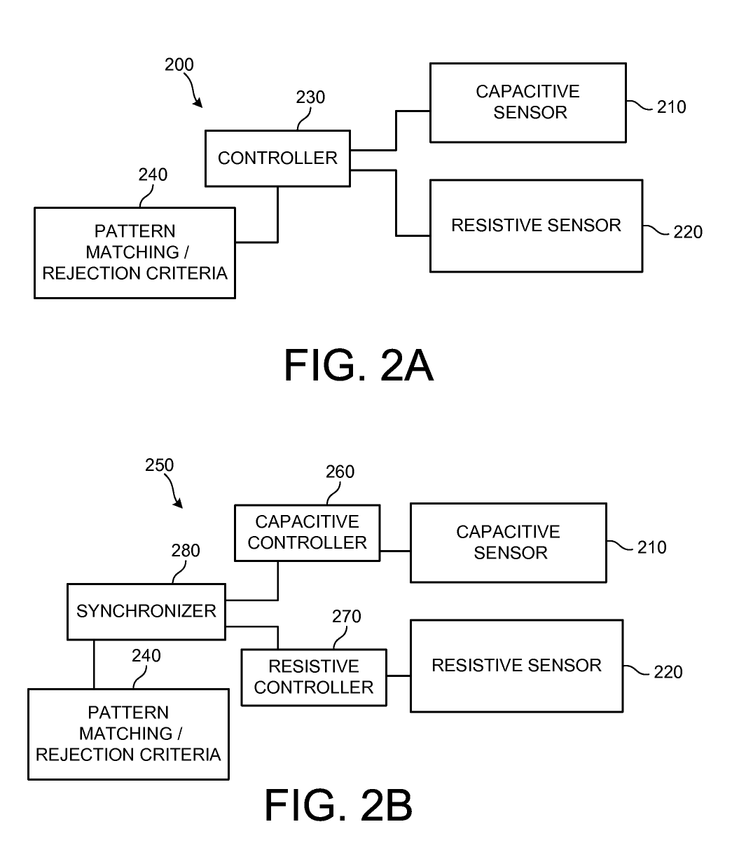

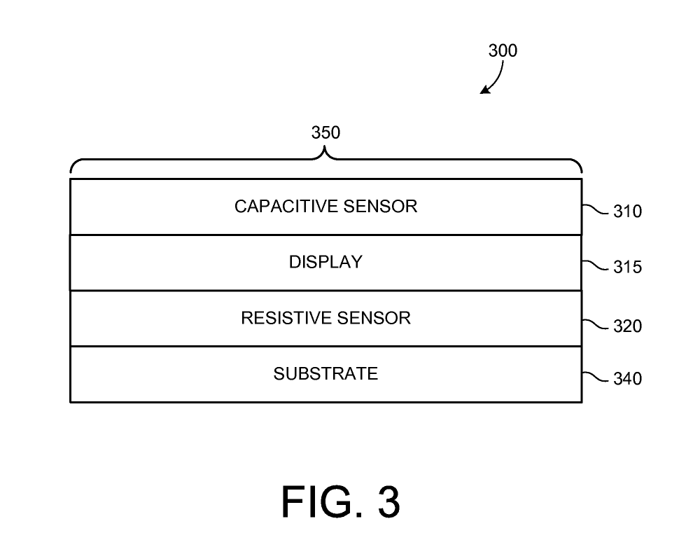

FIG. 2A is a block diagram illustrating components of a pressure-sensitive touch surface apparatus 200 in accordance with an example implementation. The touch surface apparatus 200 may be a trackpad or may be a touchscreen display. The touch surface 200 may be implemented, for example, in the computing device 100 as the trackpad apparatus 130 or the touchscreen display 110 and in the computing device 150 as the keyboard and trackpad apparatus 170 or the touchscreen display 160. The touch surface 200 also may be implemented, for example, in the computing device 190 as the touchscreen display 195. Of course, the touch surface 200 may be implemented in conjunction with other computing devices and the computing devices 100, 150 and 190 may include pressure-sensitive touch surfaces having other configurations. For example, FIG. 2A illustrates a single controller 230. In other example implementations, more than one controller may be used, for instance as discussed below in more detail below with respect to FIG. 2B.

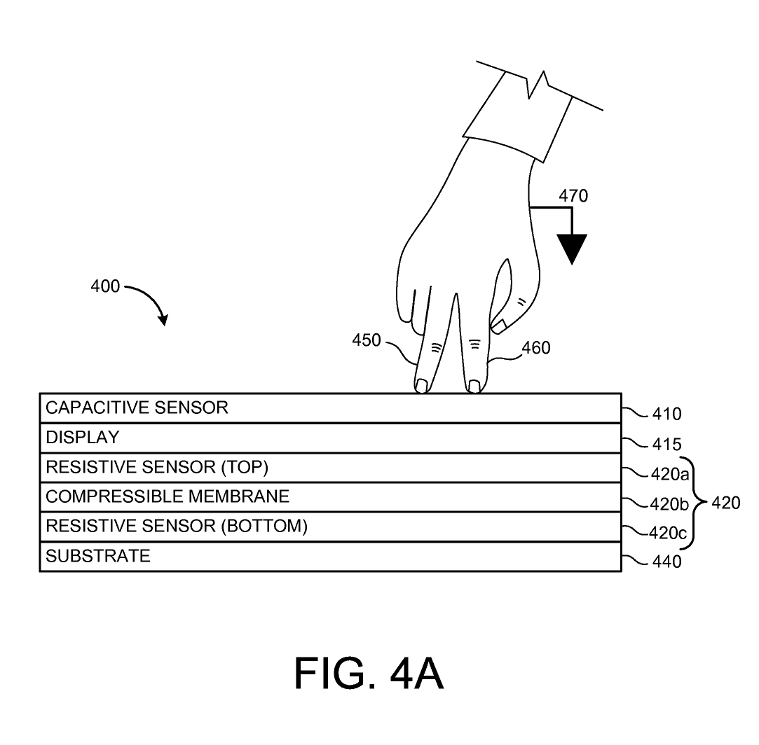

As shown in FIG. 2A, the touch surface apparatus 200 includes a capacitive sensor 210 (also referred to as a capacitive touch-sensing pattern), a resistive sensor 220 (also referred to as a resistive touch-sensing pattern), a controller 230 and pattern matching/rejection criteria 240. It will be appreciated that the configuration of the touch surface 200 is given by way of example and for purposes of illustration. In certain implementations, the touch surface 200 may include other elements, or may be arranged in different fashions. For instance, the touch surface 200 may include an insulating layer that is disposed between the capacitive sensor 210 and the resistive sensor 220. In other instances, the pattern matching/rejection criteria 240 may be included in the controller 230. In still other implementations, pattern matching and/or pattern rejection, such as described herein, may be performed by other elements of a computing system (e.g., other than the controller 230) in which the touch surface 200 is implemented. In still other implementations, the touch surface apparatus 200 may be implemented as a touchscreen display device, in which a display component is included as part of the touch surface apparatus, as shown and described in more detail with respect to FIG. 3.

In the touch surface 200, the capacitive sensor 210 may be disposed on a top surface of the touch surface 200 and provide a tactile sensing surface for detecting (e.g., in conjunction with the controller 230) the presence and/or movement of one or more electrically conductive and electrically grounded objects, such as a user's finger or fingers, for example. In an example implementation, the capacitive sensor 210 may be implemented using a multi-layer array (matrix) of capacitors. In such an approach, the capacitive sensor 210 may include a top layer of closely-spaced, parallel-arranged conductors and a bottom layer of closely-spaced, parallel-arranged conductors that are oriented in a perpendicular arrangement with the conductors of the top layer. The top layer and the bottom layer of the capacitive sensor 210 may be separated by an insulating (dielectric) layer, such that the conductors in the top layer and the bottom layer form respective capacitors, through the dielectric layer, at each crossing point of a conductor in the top layer and a conductor in the bottom layer. Such an arrangement may be used to form a tightly spaced matrix of capacitors. In one example implementation, the capacitive sensor 210 may be a single layer sensor. In other example implementations, the capacitive sensor 210 may be a multi-layer capacitive sensor.

In such an approach, the controller 230 may be configured to sequentially apply a high frequency signal (e.g., an alternating current (AC) signal) between conductor pairs in such a two-dimensional capacitor matrix. The amount of charge that is coupled through the capacitors at each crossing point of the conductors of the top layer and the conductors of the bottom layer of capacitive sensor 210 would be proportional to the respective capacitance at each crossing point. When the sensing surface of the capacitive sensor 210 does not have any electrically conductive objects in contact with it, charge coupling may be substantially uniform across the capacitive matrix of the capacitive sensor 210.

However, when an electrically grounded object (e.g., an object that is electrically grounded relative to the top layer of the capacitive sensor 210), such as a user's finger or fingers, is (are) placed in contact with the sensing surface of the capacitive sensor 210, some of the charge from the capacitors in the contacted area or areas would be shunted to the grounded object or objects. The charge that is shunted to the grounded object or objects would then result in a change (e.g., a decrease) in the apparent capacitance in the area or areas with which the electrically grounded objects or objects are in (electrical) contact with the capacitive sensor 210.

The controller 230 may be configured to detect such changes in apparent capacitance by detecting location-specific reductions in charge coupling (e.g., at the contacted areas) in the capacitive sensor 210. Accordingly, the controller 230, in conjunction with the capacitive sensor 210, may detect the position or positions of a user's finger or fingers on the capacitive sensor 210 and/or movement of a user's finger or fingers across the capacitive sensor 210 based on detection and/or changes in location of such location-specific reductions in charge coupling. Of course, other approaches for implementing the capacitive sensor 210 are possible. For purposes of this disclosure, such detected location-specific reductions in charge coupling corresponding with the position(s) of a user's finger or fingers and/or movement of a user's finger or fingers on the capacitive sensor 210 may be referred to, hereinafter, as “touch data” or “detection information” or “information from the detection by the controller and the capacitive sensor.”

In the touch surface 200, the resistive sensor 220 may be disposed below the capacitive sensor 210. The resistive sensor 220 may be implemented using a multi-layer array of resistive elements that includes a top layer of closely-spaced, parallel-arranged resistive elements and a bottom layer of closely-spaced, parallel-arranged resistive elements that are oriented in a perpendicular arrangement with the resistive elements of the top layer. The top layer and the bottom layer of the resistive sensor 220 may be separated by a compressible membrane layer, such as a spacer matrix or dot matrix.

In such an approach, the controller 230 may be configured to sequentially apply a direct current (DC) signal (e.g., a DC voltage) between resistive elements of the resistive sensor 220. The controller in conjunction with the resistive sensor 220 is configured to measure an amount of force applied by measuring a voltage conducted through the resistive sensor layers. The amount of voltage that is present through the resistive elements at each crossing point of elements in the top layer and the elements in the bottom layer would be proportional to the respective voltage at each crossing point. When the resistive sensor 220 is not displaced (e.g., at one or more locations) by an object or objects (e.g., a user's finger or fingers) applying pressure to the surface of the touch surface 200, voltage across the resistive sensor 220 may be substantially uniform across its resistive matrix.

However, when pressure is applied at one or more locations on the surface of the touch surface 200, this pressure may cause location-specific displacement of the resistive sensor 220 at a location or locations that is (are) coincident with the location or locations where such pressure is applied. Such location-specific displacement of the resistive sensor 220 may result in corresponding location-specific changes in voltage in the resistive sensor 220. Depending on the particular implementation, such location-specification changes in voltage corresponding with the location or locations at which pressure is applied may be detected (e.g., by the controller 230) as location-specific increases in voltage in the resistive sensor 220. The resistance drops through the area where pressure is applied.

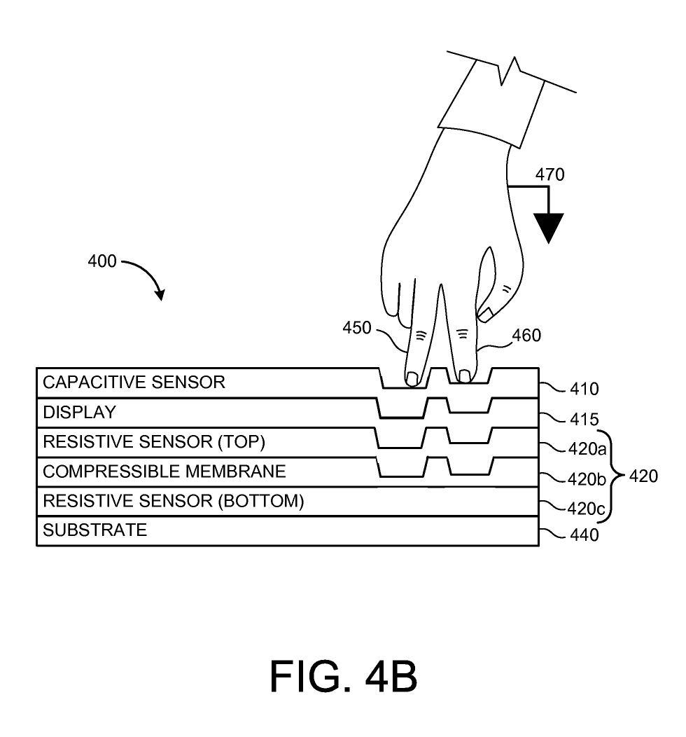

For instance, such location-specific changes in voltage in the resistive sensor 220 may be detected as location-specific increases in voltage (such as in the implementation shown in FIGS. 4A and 4B). The implementations illustrated in FIGS. 4A and 4B will be described in further detail below. For purposes of this disclosure, such detected location-specific changes in voltage resulting from pressure applied to one or more locations on a touch surface may be referred to, hereinafter, as “pressure data” or “force data” or “detection information” or “information from the detection by the controller and the resistive sensor.”

In the touch surface apparatus 200 shown in FIG. 2A, the controller 230 may implemented in a number of manners. For instance, the controller 230 may be implemented using a general purpose programmable processor or controller. In other implementations, the controller 230 may be implemented using an application specific integrated circuit. In still other approaches, the controller 230 may be implemented using firmware and/or software in the form of machine readable instructions that may be executed by a general purpose processor or controller. The controller 230 may also be implemented using a combination of the techniques discussed above, or may be implemented using other techniques and/or devices.

The controller 230 may be configured to generate and coordinate detection scans of the capacitive sensor 210 and the resistive sensor 220 simultaneously or nearly simultaneously. Both sensors, the capacitive sensor 210 and the resistive sensor 220, function independent of one another. As discussed above, the controller 230 applies an AC signal to the capacitive sensor 210 and a DC signal to the resistive sensor 220, so there is no risk of interference between the signals. The signals from the capacitive sensor 210 can be measured independently from the signals from the resistive sensor 220. Similarly, the signals from the resistive sensor 220 can be measured independently from the signals from the capacitive sensor 210.

In an example implementation, the controller 230 may use the pattern matching/rejection criteria 240 (which is referred to, hereinafter, as pattern filtering criteria 240) to filter touch data and pressure data received from, respectively, the capacitive sensor 210 and the resistive sensor 220.

Briefly, however, the controller 230 may be configured to resolve one or more geometric patterns corresponding with touch data received from the capacitive sensor 210. For instance, if a user places two fingers in contact with the capacitive sensor 210, the controller 230 may resolve respective geometric patterns associated with each of the user's fingers that are in contact with the capacitive sensor 210 from touch data (e.g., location-specific reductions in charge coupling) corresponding with each of the user's fingers. The controller 230 may be further configured to compare the resolved geometric patterns with the pattern filtering criteria 240 and accept or reject the touch data (or portions of the touch data) based on that comparison.

Such an approach may allow the touch surface apparatus 200 to reject touch data that may be inadvertent or undesirable to use when interacting with a GUI. For example, the pattern filtering criteria 240 may be used to reject touch data that results from a user resting his or her palm, or the side of his or her hand on the touch surface 200. Further, the pattern filtering criteria 240 may also be used to accept touch data with certain patterns, such as patterns that correspond with a user's fingertip or fingertips. The controller 230 also may be configured to filter pressure-data in a similar fashion, e.g., by resolving geometric patterns in the pressure data and comparing those resolved patterns with the pattern filtering criteria 240.

In other implementations, the controller 230 may be configured to correlate touch data with pressure data and filter the pressure data based on both the geometric patterns resolved from the touch data and the pattern filtering criteria 240. In such an approach, if the controller 230 identifies pressure data that does not have corresponding touch data (e.g., a coincident location), that pressure data may be filtered out and not provided to a corresponding computing device to affect interaction with a GUI. Also, in such an implementation, pressure data that does have corresponding touch data may be further filtered by applying geometric patterns resolved from the touch data (e.g., at coincident location(s)) and the pattern filtering criteria 240 to the pressure data. Similarly, if the controller 230 identifies touch data that does not have corresponding pressure data (e.g., a coincident location), that touch data may be filtered out and not provided to a corresponding computing device to affect interaction with a GUI.

In one example implementation, a top surface of the touch surface 200 may be divided into a plurality of regions. The controller 230 may be configured to determine the locations of one or more objects on the top surface by using detections by the capacitive sensor 210 in one or more of the regions to filter the detections with the resistive sensor 220 in the same regions.

The controller 230 may also be configured to detect movement of one or more electrically conductive objects (e.g., a user's finger or fingers) across the top surface of the touch surface apparatus based on movement of the detected location-specific reductions in charge coupling in the capacitive touch-sensing pattern. For instance, the controller 230 may be configured to compare current touch data with previous touch data in order to detect such movement. In like fashion, the controller 230 may also be configured to detect one or more objects applying pressure and moving across the top surface of the touch surface apparatus based on changes in pressure data. For example, the controller 230 may be configured to compare current pressure data with previous pressure data to detect such movement. In such approaches, filtered pressure data may be used to indicate mouse clicks, or may be used to indicate other desired interactions with a GUI, thus allowing a user to interact with objects in a GUI (e.g., select objects, launch programs from icons and/or move objects) without having to use separate buttons.

In other implementations, the controller 230 may be configured to use the detected information from the capacitive sensor 210 and the detected information from the resistive sensor 220 independent of each other. For example, the controller 203 may be configured to use the touch data from the capacitive sensor 210 for position and tracking information (e.g., in the X-Y directions on the touch surface 200). Independent of the information from the capacitive sensor 210, the controller 230 may be configured to use the pressure data from the resistive sensor 220 for click, selection, and tapping information (e.g., in the Z direction on the touch surface 200). In some implementations, for example in a touchscreen display implementation, the capacitive sensor 210 may be disposed on a top surface of the display and the resistive sensor 220 may be disposed below (or on a bottom surface of) the display. In this example, the resistive sensor 220 may not provide the desired accuracy in position and tracking information since the resistive sensor 220 is disposed below the display. However, the resistive sensor 220 may still provide the desired accuracy in the pressure data. This implementation is discussed further with respect to FIGS. 3, 4A and 4B.

Referring to FIG. 2B, an example touch surface 250 is illustrated. The touch surface 250 may be implemented, for example, in the computing device 100 as the trackpad apparatus 130 or the touchscreen display 110 and in the computing device 150 as the keyboard and trackpad apparatus 170 or the touchscreen display 160 of FIGS. 1A and 1B. The touch surface 250 also may be implemented as the touchscreen display 195 in the computing device 190 of FIG. 1C. Of course, the touch surface 250 may be implemented in conjunction with other computing devices and the computing devices 100, 150 and 190 may include pressure-sensitive trackpads and touchscreen displays having other configurations.

The touch surface 250 may function similar to the touch surface 200 of FIG. 2A with a difference being that the touch surface 250 includes a capacitive controller 260 and a resistive controller 270 in place of the single controller 230 of FIG. 2A. The touch surface 250 also includes a synchronizer 280 to synchronize the detection scans from both the capacitive controller 260 and the resistive controller 270. The capacitive controller 260 and the resistive controller 270 divide the functionality of the controller 230 of FIG. 2A with the capacitive controller 260 operatively coupled to the capacitive sensor 210 and the resistive controller 270 operably coupled to the resistive sensor 220. The capacitive controller 260 is configured to work in conjunction with the capacitive sensor 210 in the same manner controller 230 worked in conjunction with the capacitive sensor 210, as described above with respect to FIG. 2A. Similarly, the resistive controller 270 is configured to work in conjunction with the resistive sensor 220 in the same manner controller 230 worked in conjunction with the resistive sensor 220, as described above with respect to FIG. 2A.

The synchronizer 280 is configured to coordinate with the capacitive controller 260 and the resistive controller 270 to run detection scans simultaneously or nearly simultaneously such that the scans both complete at substantially a same time in order to run efficiently.

FIG. 3 is a diagram illustrating a pressure-sensitive touchscreen display 300 in accordance with an example implementation. The touchscreen display 300 shown in FIG. 3 illustrates an example structure that may be used to implement a pressure-sensitive touch screen display apparatus. For instance, the structure of the touchscreen display 300 may be used to implement the touchscreen display 110, the touchscreen display 160 and the touchscreen display 195 of FIGS. 1A-1C, respectively. The structure of the touchscreen display 300 may be used to implement the touch surface apparatus 200 shown in FIG. 2A and the touch surface apparatus 250 shown in FIG. 2B. Also, while not shown in FIG. 3, the touchscreen display 300 may be coupled with a controller in like fashion as shown for the controller 230 in the touch surface apparatus 200 illustrated in FIG. 2A or the controllers 260 and 270 and synchronizer 280 in the touch surface 250 illustrated in FIG. 2B. Additionally, a separate display controller (not shown) may be coupled to the display layer 330. Alternatively, the controller 230 or one of the controllers 260 or 270 may be configured to function as a display controller.

As illustrated in FIG. 3, the touchscreen display 300 includes a capacitive sensor 310, a display 315, a resistive sensor 320, and a substrate 340. The capacitive sensor 310 is disposed on a top surface of the display 315. That is, the capacitive sensor 310 is user-facing on a top of the display 315. The resistive sensor 320 may be disposed on a bottom surface of the display 315, such that the resistive sensor 320 is not user-facing. Instead, the resistive sensor 320 is hidden from view from a user because the display 315 is on top of the resistive sensor 320. That is, the resistive sensor 320 is under or beneath the display 315. The upper surface 350 of the touchscreen display 300 may operate as a tactile sensing surface for the touchscreen display 300 to gather touch data, such as in the manners described herein.

In the touchscreen display 300, the capacitive sensor 310 and the resistive sensor 320 may be implemented and operate in a similar fashion as was discussed above with respect to the capacitive sensor 210 and the resistive sensor 220 of the touch surfaces 200 and 250 shown in FIGS. 2A and 2B. Accordingly, for purposes of brevity and clarity, the entirety of the details of the capacitive sensor 210 and the resistive sensor 220 are not repeated again here with respect to the capacitive sensor 310 and the resistive sensor 320.

In one implementation, the capacitive sensor 310 may be implemented using transparent materials such as, for example, polyethylene terephthalate (PET) substrate coated with indium tin oxide (ITO) traces. In other implementations, the capacitive sensor 310 may be implemented using other materials such as a glass substrate coated with ITO traces. The capacitive sensor 310 may be formed using other types of transparent materials. The capacitive sensor 310 may be a single layer sensor with a single layer of traces or the capacitive sensor may be a multi-layer sensor with multiple layers of traces. The thickness of the capacitive sensor 310 may range from about 0.1 mm to about 0.2 mm.

In one implementation, the traces forming the capacitive sensor 310 may be printed on a top sealant layer of the display 315. In this example implementation, the capacitive sensor 310 may not include its own substrate since the traces are printed directly on the display 315. In this manner, the thickness of the capacitive sensor 310 may range from about 0 mm to about 0.1 mm.

In one implementation, the display 315 includes a bottom substrate. The bottom substrate may include the thin film transistors (TFTs) printed on the bottom substrate. The TFTs may be configured to turn the display on and off. The display 315 may includes liquid crystal display (LCD) layer disposed above the bottom substrate. In other implementations, the display 315 may include an e-ink layer disposed above the bottom substrate instead of an LCD layer. In other implementations, other types of layers may be used instead of an LCD layer or an e-ink layer. The layers of the display 315 may be laminated together across the area of the entire display. The thickness of the display 315 may range from about 0.4 mm to about 0.6 mm.

In one implementation, the display 315 may be a reflective display, where the reflective display is implemented in one laminated layer of material. In other implementations, the display 315 may be other types of displays.

The resistive sensor 320 may include a matrix of resistive traces across the entire surface of the sensor. The resistive sensor 320 is disposed below the display 315 such that the resistive sensor is not visible to a user using the display. As such, the resistive sensor 315 may include non-transparent materials. Of course, the resistive sensor 315 also may include transparent materials. The resistive sensor 320 may be implemented with two layers disposed on either side of a compressible membrane. The particular arrangement of the resistive matrix and the compressible membrane of the resistive sensor 320 will depend on the particular implementation. One such implementation is illustrated in FIGS. 4A and 4B, as discussed further below. Of course, other arrangements are possible. The thickness of the resistive sensor 320 may range from about 0.1 mm to about 0.3 mm.

One advantage to having the resistive sensor 320 disposed below the display 315 is that less power may be need to cause the display 315 to have an equivalent brightness for a structure where the resistive sensor 320 is disposed above the display 315. That is, less power is needed to make the display have the same brightness when the resistive sensor 320 is disposed below the display 315 when compared to the power needed when the resistive sensor 320 is disposed above the display 315. Also, when the resistive sensor 320 is disposed below the display 315, the materials for the resistive sensor 320 do not need to be made from transparent or semi-transparent material.

In the touchscreen display 300, the thickness, thickness modulus and stiffness (e.g., material) of each of the capacitive sensor 310, the display 315, the resistive sensor 320 and the substrate 340 may be selected to make each layer as thin as possible. That is, it is desirable to minimize the thickness and the thickness modulus of the capacitive sensor 310 and the display 315 in order to detect accurate pressure data by the resistive sensor 320. The thickness of the capacitive sensor 310 and the display 315 may be selected such that the compressible membrane is the first to displace when pressure is applied to the surface 350, such as by a user's finger or fingers.

In one example implementation, the combined thickness of the of the capacitive sensor 310, the display 315 and the resistive sensor 320 may be from about 0.7 mm to about 1.1 mm. Of course, other ranges of thickness are possible based on the selected thickness of the materials used in each layer.

In one example implementation, the capacitive sensor 310 may be laminated to a top of the display 315. The resistive sensor 320 may be laminated to a bottom of the display 315. The laminated assembly of the capacitive sensor 310, the display 315 and the resistive sensor 320 may be laminated or otherwise fastened to the substrate 340 as a touchscreen display in a computing device, such as one of the computing devices illustrated and described above.

In one example implementation, the capacitive sensor 310, the display 315 and the resistive sensor 320 may use the same or similar polymer materials such that the coefficients of thermal expansion are similar for all of the layers. In this manner, there may be no uneven stresses as the materials are heated during the lamination process(es). Additionally, using the same or similar polymer materials such that the coefficients of thermal expansion are similar for all of the layers may prevent uneven stresses of the materials exhibiting ranges of temperatures during normal use. For example, the capacitive sensor 310, the display 315 and the resistive sensor 320 may use PET substrates, where needed. Using a PET substrate instead of a glass substrate also may be advantageous during the lamination process and during normal use because the PET substrate is less prone to cracking, whereas the glass substrate may be prone to cracking.

FIGS. 4A and 4B are diagrams illustrating operation of a pressure-sensitive touchscreen display apparatus 400, in accordance with an example implementation. The touchscreen display 400 shown in FIGS. 4A and 4B illustrates another example structure of a pressure-sensitive touchscreen display apparatus that may be used to implement the touch surface devices 200 and 250 and the touchscreen display 300 shown, respectively, in FIGS. 2A, 2B and 3. Accordingly, for illustrative purposes, like elements of the touchscreen display 400 are referenced with 400 series reference numbers corresponding with the 200 and 300 series reference numbers used in FIGS. 2A, 2B and 3. While not shown in FIGS. 4A and 4B, the touchscreen display 400 may be coupled with a controller in like fashion as shown for the controller 230 in the touch surface device 200 illustrated in FIG. 2A or multiple controllers 260 and 270 and synchronizer 280 illustrated in FIG. 2B.

As illustrated in FIGS. 4A and 4B, the touchscreen display 400 includes a capacitive sensor 410 disposed on a display 415 and a resistive sensor 420 disposed below the display 415. The resistive sensor 420 may be disposed on a substrate 440. In the touchscreen display 400, the resistive sensor 420 includes a resistive sensor top layer 420a, a compressible membrane 420b that is disposed below the resistive sensor top layer 420a and a resistive sensor bottom layer 420c.

The compressible membrane 420b may be implemented using, for example, silicone, synthetic polymers, such as polyethylene terephthalate (PET), air, or a combination these or other materials. For instance, in an example implementation of the touchscreen display 400, the compressible membrane 420b may include a matrix of PET spacer dots, which creates a gap between the resistive sensor top 420a and the resistive sensor bottom 420c, while the rest of the compressible membrane 420b is air. In one example implementation, the compressible membrane 420b may be a substance which varies its electrical resistance depending on the amount of compression. The specific materials used will, of course, depend on the particular implementation.

As was discussed with respect to the touchscreen display 300, the stiffness (materials) of each of the capacitive sensor 410; the display 415; the resistive sensor layers 420a and 420c; and the compressible membrane 420b may be selected such that the compressible membrane 420b is the first to displace when pressure is applied to the top surface of the touchscreen surface 400, such as by a user's finger or fingers. Of course, the other layers disposed above the compressible membrane 420b may displace a little because they are disposed above the compressible membrane. Further, the substrate 440 may be implemented in like fashion as was discussed above with respect to the substrate 340, e.g., so as to be resistant to displacement.

In the touchscreen display 400, the capacitive sensor 410 and the resistive sensor 420 may be implemented and operate in a similar fashion as was discussed above with respect to the capacitive sensor 210 and the resistive sensor 220 of the touch surface devices 200 and 250 shown in FIGS. 2A and 2B. Accordingly, for purposes of brevity and clarity, the entirety of the details of the capacitive sensor 210 and the resistive sensor 220 are not repeated again here with respect to the capacitive sensor 410 and the resistive sensor 420.

In FIGS. 4A and 4B, a user's fingers 450 and 460 are illustrated as being in contact (e.g., electrical contact) with a top surface of the touchscreen display 400. The fingers 450 and 460 are also shown as being connected to an electrical ground 470, where the user would provide an electrical ground with respect to the top surface of the touchscreen display 400.

In like fashion as previously described, the user's fingers 450 and 460 may shunt charge away from the capacitive sensor 410 to the electrical ground 470, thereby changing the apparent capacitance of the capacitive sensor 410 where it is contacted by the user's fingers 450 and 460. A controller, such as the controller 230 (or controller 260 of FIG. 2B), (not shown in FIGS. 4A and 4B) coupled with the touchscreen display 400 may detect such changes in apparent capacitance (as touch data) by detecting corresponding reductions in charge coupling in the capacitive sensor 410 where it is contacted by the user's fingers 450 and 460. Additionally, movement of the user's fingers 450 and 460 across the surface of the touchscreen display 400 may be detected using the techniques described here, such as those that were discussed above with respect to FIGS. 2A and 2B.

As shown in FIG. 4A, the user's fingers 450 and 460 are not applying pressure to the surface of the touchscreen display 400. In this situation, voltage in the resistive sensor 420 would be substantially uniform across its resistive matrix.

The compressible membrane 420b is disposed between the resistive layers 420a and 420b of the resistive sensor 420 of the touchscreen display 400. Therefore, in this embodiment, the compressible membrane 420b is part of the resistive sensor 420.

As shown in FIG. 4B, pressure is being applied to the surface of the touchscreen display 400 by the fingers 450 and 460, with more pressure being applied by the finger 450 than by the finger 460. As illustrated, the pressure by the fingers 450 and 460 results in corresponding displacements of the compressible membrane 420b, the resistive layer 420a, the display 415 and the capacitive sensor 410. As discussed above, the stiffness of each of these layers may be selected such that the compressible membrane 420b is the first displace when pressure is applied to the surface of the touchscreen display 400.

In this situation, the displacements of the resistive layer 420a and the compressible membrane 420b under the fingers 450 and 460 will cause near contact with the resistive layer 420c. The contact of the resistive layers 420a and 420c will cause respective location-specific increases in voltage (i.e., a voltage conduction) of the resistive sensor 420 where the displacements occur and corresponding decreases in resistance of the compressible membrane as it is compressed. A controller, such as the controller 230 shown in FIG. 2A (or controller 270 of FIG. 2B), coupled with the touchscreen display 400 may detect such increases in voltage as pressure data. Movement of the fingers 450 and 460 across the surface of the touchscreen display 400 while applying pressure may be detected from such pressure data using the techniques described herein. Also, pressure data and touch data for the touchscreen display 400 may be filtered using the techniques described herein, such as discussed with reference to FIG. 2A and FIG. 2B, for example.

A controller coupled with the touchscreen display 400 may also be configured to determine the respective amount of pressure applied by each of the fingers 450 and 460 to the surface of the touchscreen display 400. For example, because the finger 450 is applying more pressure than the finger 460 and causes a larger displacement, the location-specific increase in voltage in the resistive sensor 420 associated with the displacement from the finger 450 will be greater than the voltage conduction in the resistive sensor 420 associated with the displacement from the finger 460.

The touchscreen display 400, using a controller, may be configured to determine an amount of pressure applied by each of the fingers 450 and 460, from corresponding pressure data. For instance, the pressure amounts may be determined based on respective amounts of location-specific increases in voltage in the resistive sensor 420. Such determinations may be provided to a computing system, such as the computing system 100, 150 or 190, by the touchscreen display 400 (e.g., using a controller) and may affect different actions in a GUI based on the amount of pressure applied. For example, a first amount of pressure may cause an item to be selected in a GUI and a second amount of pressure (e.g., greater than the first amount) may cause the item to be opened, such as using a default program or by running a program associated with an icon, as some examples. The amount of pressure also may be used to distinguish between selection of keys in a keyboard versus tracking gestures to control a cursor such as with combined keyboard and trackpad 170 of FIG. 1B. For example, when an amount of pressure as detected by the resistive sensor meets or exceeds a particular threshold pressure, then a keyboard action may be registered instead of a tracking gesture. Of course, such indications of an amount of pressure applied may be used in a number of other ways depending on the particular implementation and/or situation.

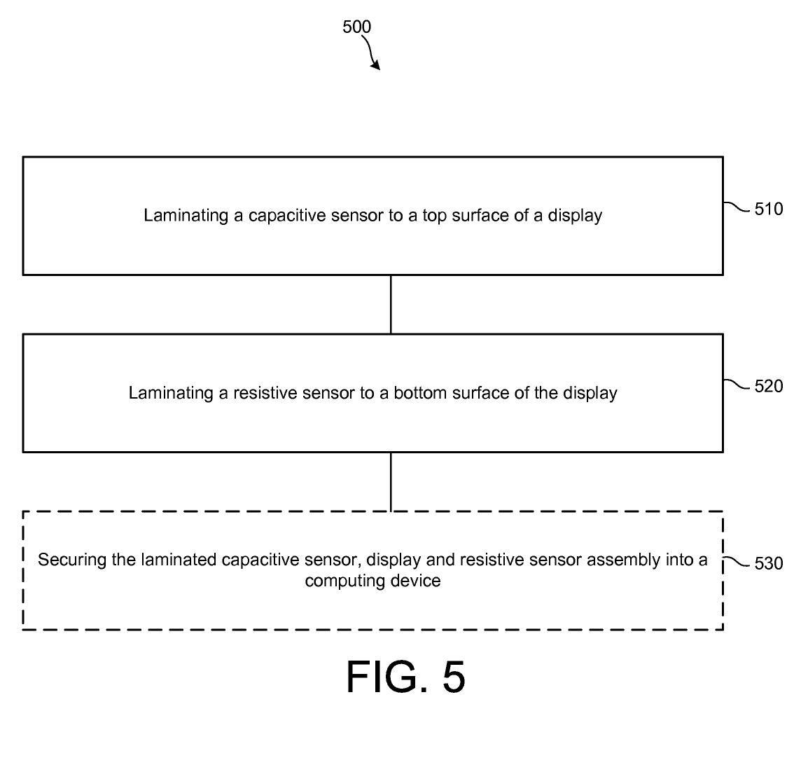

FIG. 5 is an example flow diagram illustrating an example process 500 for assembling a display apparatus. The process 500 includes laminating a capacitive sensor to a top surface of a display (510). For example, the capacitive sensor 310 may be laminated to a top surface of a display 315. Process 500 includes laminating a resistive sensor to a bottom surface of the display (520). For example, the resistive sensor 320 may be laminated to a bottom surface of the display 315. In this manner, the resistive sensor 320 may include non-transparent materials since the resistive sensor 320 is disposed below the display 315. In one example implementation, the capacitive sensor, the display and the resistive sensor may use PET substrates, where needed, instead of glass substrates because glass substrates may be more prone to cracking during the lamination process. Also, the capacitive sensor, the display and the resistive sensor may use the same or similar polymer materials, where needed, such that the layers have similar coefficients of thermal expansion to prevent uneven stresses during the lamination process.

Process 500 also may include securing the laminated capacitive sensor, the display and the resistive sensor assembly into a computing device (530). For example, the laminated capacitive sensor 310, display 315 and resistive sensor 320 assembly may be secured into computing device 100, 150 or 190 of FIGS. 1A-1C.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A display apparatus, comprising:
a display;
a capacitive sensor disposed on a top surface of the display; and
a resistive sensor disposed on a bottom surface of the display.

2. The display apparatus of claim 1 wherein the capacitive sensor is laminated to the top surface of the display and the resistive sensor is laminated to the bottom surface of the display.

3. The display apparatus of claim 1 wherein the resistive sensor comprises a plurality of traces and the traces comprise transparent material.

4. The display apparatus of claim 1 wherein the resistive sensor comprises a plurality of traces and the traces comprise non-transparent material.

5. The display apparatus of claim 1 further comprising at least one controller operably coupled to the capacitive sensor and to the resistive sensor.

6. The display apparatus of claim 5 wherein:
the at least one controller and the capacitive sensor are configured to detect one or more objects on the top surface of the display independent of the resistive sensor; and
the at least one controller is configured to determine positioning and tracking of the one or more objects on the top surface using information from the detection by the at least one controller and the capacitive sensor.

7. The display apparatus of claim 5 wherein:
the at least one controller and the resistive sensor are configured to detect one or more objects on the top surface of the display independent of the capacitive sensor; and
the at least one controller is configured to determine click gestures and key presses from the one or more objects on the top surface using information from the detection by the at least one controller and the resistive sensor.

8. The display apparatus of claim 1 wherein the display includes a liquid crystal display (LCD) layer.

9. The display apparatus of claim 1 wherein the display includes an e-ink display layer.

10. A method for assembling a display apparatus, the method comprising:
laminating a capacitive sensor to a top surface of a display; and
laminating a resistive sensor to a bottom surface of the display.

11. The method as in claim 10 wherein the resistive sensor comprises a plurality of traces and the traces comprise transparent material.

12. The method as in claim 10 wherein the resistive sensor comprises a plurality of traces and the traces comprise non-transparent material.

13. The method as in claim 10 further comprising securing the laminated capacitive sensor, display and resistive sensor assembly into a computing device.

14. The method as in claim 10 wherein the capacitive sensor, the display and the resistive sensor include a polyethylene terephthalate (PET) substrate.

15. A computing device, comprising:
at least one processor;
at least one memory; and
a display apparatus, the display apparatus comprising:
a display,
a capacitive sensor disposed on a top surface of the display, and
a resistive sensor disposed on a bottom surface of the display.

16. The computing device of claim 15 wherein the capacitive sensor is laminated to the top surface of the display and the resistive sensor is laminated to the bottom surface of the display.

17. The computing device of claim 15 wherein the resistive sensor comprises a plurality of traces and the traces comprise transparent material.

18. The computing device of claim 15 wherein the resistive sensor comprises a plurality of traces and the traces comprise non-transparent material.

19. The computing device of claim 15 further comprising at least one controller operably coupled to the capacitive sensor and to the resistive sensor.

20. The computing device of claim 15 wherein the display includes a liquid crystal display (LCD) layer.

21. The computing device of claim 15 wherein the display includes an e-ink display layer.
